(19) United States
(12) Patent Application Publication
(10) Pub. No.: US 2026/0141353 A1
(43) Pub. Date: May 21, 2026

(54) SYSTEM AND METHOD FOR TASK MANAGEMENT

(71) Applicant: Workstorm.com LLC, Chicago, IL (US)

(72) Inventors: Raj FERNANDO, Chicago, IL (US); Nicholas STECH, Chicago, IL (US); Anatoliy YUDOVICH, Riverwoods, IL (US); Michael William BARRY, Chesterfield, MO (US); Angela Christine KOVACH, Alexandria, VA (US); Harris Yegha DINGA, Brockton, MA (US)

(21) Appl. No.: 18/951,440

(22) Filed: Nov. 18, 2024

(51) Int. Cl. G06Q 10/1093; G06Q 10/0631

(52) U.S. Cl. CPC G06Q 10/1097; G06Q 10/06311

(57) ABSTRACT

Disclosed herein are system, method, and computer program product embodiments for managing tasks. An embodiment includes a database and a messaging server. The messaging server generates a task graphical user interface (GUI) that includes one or more parameters for a task in a stream. The stream has permissions specifying which role a user must have to access the stream. The messaging server receives, via the task GUI, a command specifying the one or more parameters. In response to the command, the messaging server generates metadata reflecting the one or more parameters as specified by the command. The messaging server stores the metadata in a database. The messaging server displays, at a client device, the task according to the metadata on a workspace GUI that includes at least one chat panel, at least one file panel, and at least one task panel.

### BACKGROUND

### Field

This field is generally related to a messaging system that provides task management within a matter-based streams structure.

### Background

As the demands of the workplace evolve, organizations have started using various independent software applications to manage communications and file sharing. However, these software applications typically do not interface well with each other, thereby creating isolated siloes of information. As a result, employees have been responsible for managing their own activities using information scattered across disparate messaging, project management, and file management systems. Therefore, employees tend to waste valuable time toggling between vastly different software environments, which inhibits time tracking, billing, and efficiency. Furthermore, the absence of a unified administrative system for these employees may exacerbate the problem due to inefficient communications, poor project management, and improper data retention. As a result, the use of isolated messaging systems and file management systems without administrative supervision may negatively impact workplace productivity and may raise legal compliance issues.

### BRIEF SUMMARY

Accordingly, it is desirable to provide a centralized and secure platform that enables users to seamlessly collaborate and manage matter-related tasks, all while being supervised by administrative control. For example, a single integrated platform can help users to spend less time looking for information and more time focusing on project outcomes, thereby improving workflow, increasing productivity, and keeping relevant people informed of progress.

In an embodiment, a system includes a database and a messaging server. The messaging server may generate a task graphical user interface (GUI) that includes one or more parameters for a task in a stream. The stream may have permissions specifying which role a user must have to access the stream. The messaging server may receive, via the task GUI, a command specifying the one or more parameters. In response to the command, the messaging server may generate metadata reflecting the one or more parameters as specified by the command. The messaging server may store the metadata in a database. The messaging server may display, at a client device, the task according to the metadata on a workspace GUI that includes at least one chat panel, at least one file panel, and at least one task panel.

Computer-implemented method and computer program product embodiments are also disclosed.

Further embodiments, features, and advantages of the invention, as well as the structure and operation of the various embodiments, are described in detail below with reference to accompanying drawings.

### BRIEF DESCRIPTION OF THE DRAWINGS

The accompanying drawings, which are incorporated herein and form a part of the specification, illustrate embodiments of the present disclosure and, together with the description, further serve to explain the principles of the disclosure and to enable a person skilled in the relevant art(s) to make and use the embodiments described herein.

FIG. 1 is a block diagram of a messaging environment, according to some embodiments.

FIG. 2 is a block diagram of a messaging system with streams managed by an administrator, according to some embodiments.

FIG. 3 is a diagram that illustrates a graphical user interface of a streams dashboard displaying a workspace, according to some embodiments.

FIGS. 4A-4C are diagrams that illustrate a graphical user interface displaying a task settings panel, according to some embodiments.

FIG. 5 is a diagram that illustrates a graphical user interface displaying a custom field creation panel, according to some embodiments.

FIG. 6 is a diagram that illustrates a graphical user interface displaying a task settings panel activated on an email interface, according to some embodiments.

FIG. 7 is a diagram that illustrates a graphical user interface displaying a tasks dashboard, according to some embodiments.

FIG. 8 is a flowchart that illustrates a method for creating a task, according to some embodiments.

FIG. 9 is an example computer system useful for implementing various embodiments.

The present disclosure will be described with reference to the accompanying drawings. Generally, the left-most digit(s) of a reference number identifies the drawing in which the reference number first appears.

### DETAILED DESCRIPTION

Provided herein are system, apparatus, device, method and/or computer program product embodiments, and/or combinations and sub-combinations thereof, for managing tasks within streams managed by administrative control.

Various embodiments of these features will now be discussed with respect to the corresponding figures.

### Example Managed Streams Structure

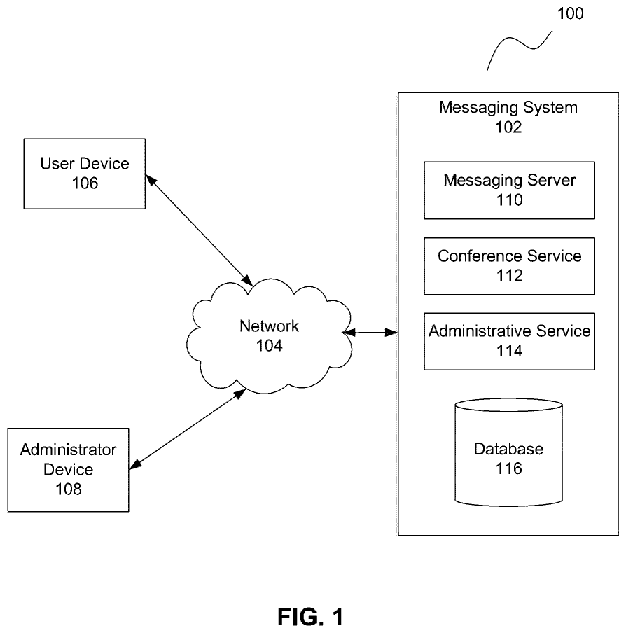

FIG. 1 is a block diagram of a messaging environment 100, according to some embodiments. Messaging environment 100 includes messaging system 102, network 104, at least one user device 106, and/or at least one administrator device 108. Messaging system 102 may include messaging server 110, conference service 112, administrative service 114, and/or database 116.

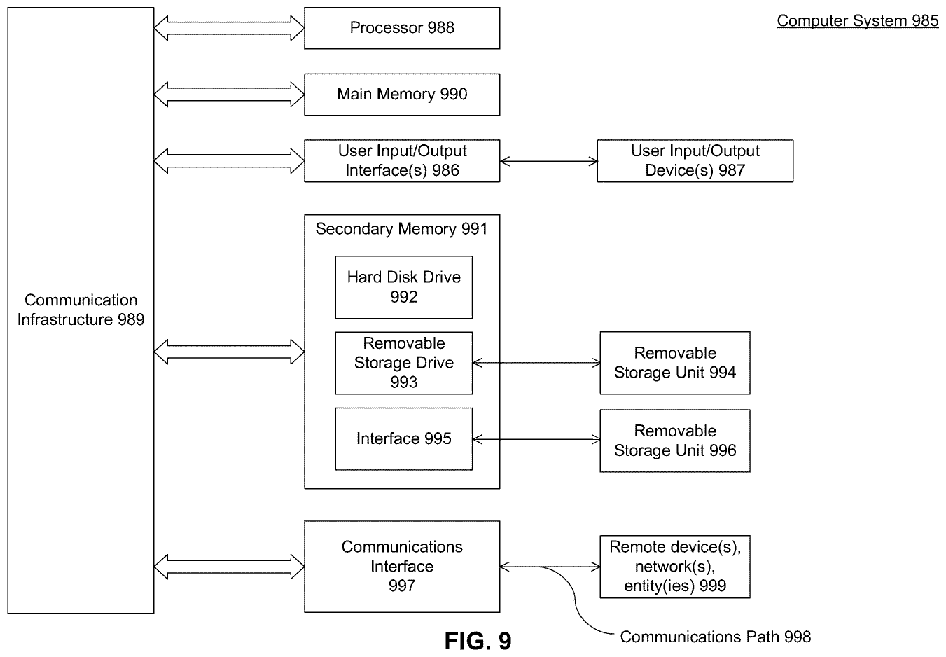

Messaging system 102 may be a computer system such as computer system 900 described with reference to FIG. 9. Messaging system 102 may be implemented using Internet-based components. For example, messaging system 102 may be implemented using one or more servers and/or databases. Messaging system 102 may facilitate communications between one or more user devices 106. For example, messaging system 102 may facilitate video conferences, audio calls, chat channels, and/or GUIs for communications.

Messaging system 102 may generate streams configured to organize data related to a specified project or matter. A stream may comprise a storage space for data such as, for example, files, file folders, chat channels, tasks, calendars, a team roster list, or any other information relevant to a project or matter, thereby providing a tool for organizing data stored on a computer system or network. For example, a stream may be configured to carry at least one file, at least one chat channel, at least one task, and at least one calendar.

An administrator may use an administrator device 108 verified by administrative service 114 to control stream creation and control access to streams within messaging system 102. However, an administrator may not have access to view or modify the content within the stream such as, for example, files, chat channels, tasks, and calendars. In an embodiment, an administrator using administrator device 108 may be able to set data storage, export, deletion, and/or retention policies within a stream, while being unable to view the content of the data. Accordingly, an administrator's role within messaging system 102 may establish a beneficial privacy layer between content of a stream and data governance of the stream.

Within messaging environment 100, there may be three types of administrators: global matter administrators (GMAs), compliance officers (COs), and managers. In one embodiment, a GMA may have administrative permissions to create a stream in messaging system 102 and assign managers to the stream. GMAs may not have permissions to view content of files, chat channels, tasks, or calendars within a stream. In a business environment, GMA permissions may be established by a company administrator. In one embodiment, a CO may have read-only access to content within a stream. COs may have administrative permissions to apply a data retention policy or a legal hold to the contents of a stream for the purposes of data governance and compliance. In a business environment, CO permissions may be established by a company administrator. In one embodiment, a manager may be assigned to a stream by a GMA. Managers may have administrative permissions to create chat channels within a stream and assign users to the chat channels. Managers also may have administrative permissions to create task within a stream and assign users to the tasks.

Messaging server 110 may receive a command from a GMA using administrator device 108 to create a stream and permissions specifying which role a user must have to access the stream. In response to the command, messaging server 110 may generate the stream in database 116. Messaging server 110 may control access to the stream as specified in the permissions such that the user is able to view or modify contents of the stream only if the user has a role allowed within the permissions. For example, a task, as one of the contents of the stream, may be displayed to a user only if the user has a role allowed within the permissions.

Access to the stream can include read-only permissions of the at least one file, chat channel, task, or calendar such that a user may only have to ability to view the contents of the stream. For example, a CO may have read-only permissions of the at least one file, chat channel, task, or calendar.

Access to the stream can include permissions to edit content of the at least one file, chat channel, task, or calendar such that a user may view and modify the contents of the stream. For example, a user assigned to a stream may be able to view and modify their chat channels, tasks, calendars, and associated files.

Access to the stream can include administrative permissions to edit permissions for other users in the stream. For example, a manager may have administrative permissions to edit permissions for other users in the stream. An administrator having administrative permissions may not have read-only permissions or permissions to edit content of the at least one file, chat channel, task, or calendar. Alternatively, an administrator having administrative permissions may have read-only permissions of the at least one file, chat channel, task, or calendar. Alternatively, an administrator having administrative permissions may have permissions to edit content of the at least one file, chat channel, task, or calendar.

Within the managed stream structure, messaging system 102 may generate a streams dashboard for displaying workspaces, which may include one or more graphical user interfaces facilitating message exchanges. The workspaces may include chat panels, file management services, task management services, calendar services, meeting and/or video conferencing services, contact management, and/or other communication services. In some embodiments, to facilitate chat message communications, messaging system 102 may instantiate chat panels as well as provide an interface with user client devices, such as computers, laptops, or tablets for messaging and file sharing across messaging server 110.

Messaging server 110 may facilitate chat channel communications. Chat channel communications may include chat, messaging, or textual communications. Chat channels may be used by individual users and/or by groups of users. For example, the chat channels may correspond to direct messages, team group messaging, division group messaging and/or other hierarchical communication structures. To facilitate communications within these chat channels, messaging system 102 may generate chat panels. These chat panels may be displayed on graphical user interfaces on one or more user devices 106.

When facilitating communications via chat channels, the messaging system 102 may transmit messages to users subscribed to a particular chat channel. For example, a user assigned to a particular chat channel may utilize user device 106 to deliver a message to other assigned users. User device 106 may display a graphical user interface for the user to utilize when receiving or delivering messages. The user may use user device 106 to connect to messaging system 102, which may be configured to instantiate the chat panel. In some embodiments, messaging system 102 instantiates multiple chat panels, allowing many users to subscribe to one or more chat channels.

Messaging system 102 also includes conference service 112. Conference service 112 facilitates video conferences and/or audio calls between participants. For example, participants may use user devices 106 to join a video conference. Messaging system 102 may also facilitate chat communications for the participants of the video conference and/or audio call. For example, messaging system 102 may generate a chat channel for the video conference and/or audio call. In some embodiments, a chat channel may already exist. A user may then initiate a video conference and/or audio call with members of the chat channel using messaging system 102.

Administrative service 114 may verify that an administrator such as, for example, a GMA using administrator device 108 has the appropriate permissions to create streams or modify stream settings on messaging server 110. Administrative service 114 also may verify that an administrator such as, for example, a GMA using administrator device 108 has the appropriate permissions to control or modify permissions for users and other administrators of messaging system 102. A company administrator may set the administrative permissions that administrative service 114 verifies.

In some embodiments, messaging system 102 may also store and/or manage files. For example, these files may be stored in database 116. Database 116 may also facilitate the storage and/or sharing of these files in chat channels. In some embodiments, user devices 106 and/or administrator devices 108 may upload files and/or data from a local system for sharing. Messaging system 102 may facilitate the uploading of a file by the user devices 106 and/or administrator devices 108 and/or interface with messaging server 110 to share the uploaded file in relation to a chat panel or a task panel. In some embodiments, database 116 may include the ability to interface with external databases such as, for example, Box or FileSite.

Messaging system 102 may communicate with user devices 106 and/or administrator devices 108 via network 104. Network 104 may include any combination of wired and/or wireless networks, which may include mobile communication networks, Local Area Networks (LANs), Wide Area Networks (WANs), and/or the Internet. Messaging system 102 may use a communication interface to perform this communication. The communication interface may interface with these networks to implement bidirectional communications with one or more user devices 106 and/or administrator devices 108.

User device 106 and administrator device 108 each may be an electronic device with messaging capabilities, such as, for example, a telephone, tablet, computer, laptop, or other smart devices. User device 106 and administrator device 108 each may include physical and/or stationary workspaces. In some embodiments, messaging system 102 is implemented in a web-based platform, and user device 106 and administrator device 108 each may use a computer communications protocol to connect to messaging system 102, such as, for example, WebSocket®, HTTP, or BOSH. In an embodiment, user device 106 and administrator device 108 each may install an application to access messaging system 102.

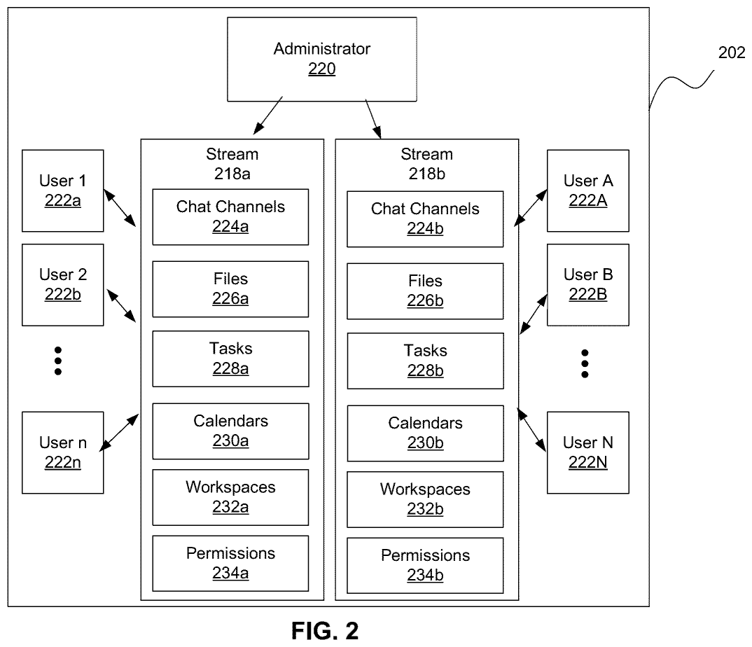

FIG. 2 is a block diagram of a messaging system 202 with streams 218a, 218b managed by an administrator 220, according to some embodiments. Messaging system 202 comprises streams 218a, 218b, users 222a . . . 222N, and administrator 220. Although FIG. 2 depicts two streams 218a, 218b (collectively referred to as streams 218), six users 222a . . . 222N (collectively referred to as users 222), and one administrator 220, messaging system 202 may comprise any number of streams, users, and administrators. In the example embodiment shown in FIG. 2, streams 218a, 218b comprise chat channels 224a, 224b (collectively referred to as chat channels 224), files 226a, 226b (collectively referred to as files 226), tasks 228a, 228b (collectively referred to as tasks 228), calendars 230a, 203b (collectively referred to as calendars 230), workspaces 232a, 232b (collectively referred to as workspaces 232), and permissions 234a, 234b (collectively referred to as permissions 234), respectively. Collectively, each stream 218 may comprise any number of chat channels 224, files 226, tasks 228, calendars 230, workspaces 232, and permissions 234.

A business organization may utilize messaging system 202 to organize data and teams with a structure comprising streams 218. Streams 218 may represent a particular project or matter. For example, a stream 218 may represent a certain litigation case or a certain stage of a litigation case. Streams 218 may be categorized by a stream name, a streams index, a stream identifier, and/or a stream type. Streams 218 may comprise a storage space for data such as, for example, chat channels 224, files 226, file folders, tasks 228, calendars 230, a team roster list, or any other information relevant to a specified project or matter, thereby providing a useful tool for organizing data on a computer system or network. For example, each one of streams 218 may be configured to carry at least one of a chat channel 224, a file 226, a task 228, or a calendar 230. In another example, each one of streams 218 may be configured to carry at least one chat channel 224, at least one file 226, at least one task 228, and at least one calendar 230. Access to each one of streams 218 may be controlled by its associated permissions 234, as specified by an administrator 220.

Administrator 220 may be a manager, as described with reference to FIG. 1. Administrator 220 may assign users 222 to one or more streams 218 and any associated chat channels 224 and/or tasks 228 for a specified project or matter. Users 222 with access to the stream 218 will then utilize the assigned chat channels 224 to receive communications from each other regarding the project or matter. For example, a team may be a group of attorneys assigned to work on a litigation project. In an embodiment, streams 218 are mandatory and specific, meaning users will not be able to leave the stream 218 and may only join a stream 218 when a manager has determined that the user should be assigned to its associated chat channels 224 and/or tasks 228. For example, if administrator 220 has assigned user 222a to stream 218a, then user 222a may not unsubscribe from stream 218a without administrator permission. Additionally, the user may not subscribe to stream 218b without administrator permission. The managed stream structure grants control to administrators 220 to tailor access for the users of chat channels 224, files 226, tasks 228, calendars 230, and workspaces 232 based on their job function within stream 218.

Streams 218 provide chat channels 224 that allow users 222 to communicate via a real-time message delivery system. Messages may include text, image, video, audio, documents, data files, compressed data files, or transaction information. In an embodiment, chat channels 224 may represent graphical user interfaces for messaging between users 222. Users 222 may view and utilize one or more chat channels 224 to send and receive messages. The graphical user interface of a chat channel 224 also provides a repository or archive of messages, so that assigned users 222 may view some or all of the messages that have ever been sent to the chat channel 224. In an embodiment, each chat channel 224 may represent a team. For example, chat channel 224a may represent a team working on a first project while chat channel 224b represents another team working on a second project.

In an embodiment, users 222 subscribe to chat channels 224, wherein users 222 may send messages to and receive messages from the chat channels 224. For example, users 222a, 222b, . . . , 222n may subscribe to chat channel 224a. User 222a may send a message to chat channel 224a, which then routes the message to the other subscribed users 222b, . . . , 222n. Users 222b, . . . , 222n may also send messages to chat channel 224a for other subscribed users to receive, including user 222a. Users 222A, 222B, . . . , 222N may subscribe to chat channel 224b but not to chat channel 224a. Because users 222A, 222B, . . . , 222N are only subscribed to chat channel 224b, they will only receive messages from chat channel 224b. Without subscribing to chat channel 224a, users 222A, 222B, . . . , 222N will not receive messages from chat channel 224a. In an embodiment, a user 222 may be subscribed to both chat channel 224a and 224b. Therefore, this user 222 may be able to send and receive messages from both chat channels 224a and 224b. In this way, the user 222 may be subscribed to two teams and may send and/or receive messages from both teams.

Streams 218 may be used to store files 226. Files 226 may be shared in chat channels 224 and/or tasks 228 that correspond to the stream 218. For example, files 226a may only be shared within chat channels 224a to maintain control over sharing permissions for stream 218a. Files 226 may be searchable by different categories such as, for example, date, channels, contacts, and/or type.

Streams 218 may include tasks 228 that allow users 222 to track objectives related to the corresponding stream 218. Tasks 228 may be displayed as a to-do list for a user 222. Each one of tasks 228 may include a name, a type, a tag, a status, a tracked time, a priority level, a deadline, a description, and/or one or more assigned users. Tasks 228 may be tracked by messaging system 202 to generate data reports. For example, messaging system 202 may track an amount of time that a user 222 spends on a particular task 228 for the purpose of calculating billable hours.

Streams 218 may include calendars 230 that allow users 222 to organize a schedule related to the corresponding stream 218. Each of calendars 230 may display meetings, appointments, or reminders for a user 222. Calendars 230 may be tracked by messaging system 202 to generate data reports. For example, messaging system 202 may track an amount of time that a user 222 spends in a particular meeting or appointment for the purpose of calculating billable hours.

Streams 218 may include workspaces 232. Workspaces 232 may include one or more panels for private message, team message, and/or division message embodiments of chat channels 224. Users 222 may send and/or receive messages via these chat channels 224 viewing in the context of a workspace 232. Workspaces 232 also may include one or more panels for files 226, one or more panels for tasks 228, and/or one or more panels for calendars 230. By utilizing a workspace 232, users 222 may be able to select different chat channels 224, files 226, tasks 228, and/or calendars 230 to view, arrange selected chat channels 224, files 226, tasks 228, and/or calendars 230 in a particular layout, and/or preserve the layout of chat channels 224, files 226, tasks 228, and/or calendars 230 for later viewing. In this manner, users 222 may arrange or organize chat channels 224, files 226, tasks 228, and/or calendars 230 into user-specified workspaces so that users 222 can access one or more chat channels 224, files 226, tasks 228, and/or calendars 230 simultaneously. Similarly, users 222 may be able to preserve a specific configuration of chat channels 224, files 226, tasks 228, and/or calendars 230 for later use so that users 222 need not create a new arrangement or workspace each time a user 222 accesses the messaging system 202. The messaging system 202 may receive configuration data from a client device and/or store the configuration data in a database for later retrieval and delivery to the client device.

Streams 218 may be controlled by associated permissions 234. Permissions 234 may define the type of access that is granted to a user 222 for content within a stream 218. Permissions 234 may be defined by any administrator such as, for example, a company administrator, a GMA, a CO, or a manager. As described with reference to FIG. 1, access to a stream 218 determined by permissions 234 may comprise at least one of read-only permissions of at least one chat channel 224, file 226, task 228, or calendar 230, permissions to edit content of at least one chat channel 224, file 226, task 228, or calendar 230, or administrative permissions to edit permissions for other users 222 in the stream 218.

Administrator 220, as a user having administrative permissions, may save a stream 218 as a stream template, or create a new stream 218 from an existing stream template, that includes a set of users 222, chat channels 224, files 226, tasks 228, and/or calendars 230 with their associated permissions 234 defined for a particular type of project or matter. Administrator 220 may use a stream template for a team of users 222 that works together on multiple projects and uses consistent naming conventions and workflows across the matters. For example, administrator 220 may use a stream template for a litigation team of users 222 that works together on a variety of projects that each represent a stage of the same litigation case. In the example embodiment shown in FIG. 2, administrator 220 may save stream 218a as a stream template specifying users 222a . . . 222n, chat channels 224a, files 226a, tasks 228a, calendars 230a, and permissions 234a to be replicated for later use upon creating another stream 218.

### Example GUIs for Managing Tasks in a Streams Structure

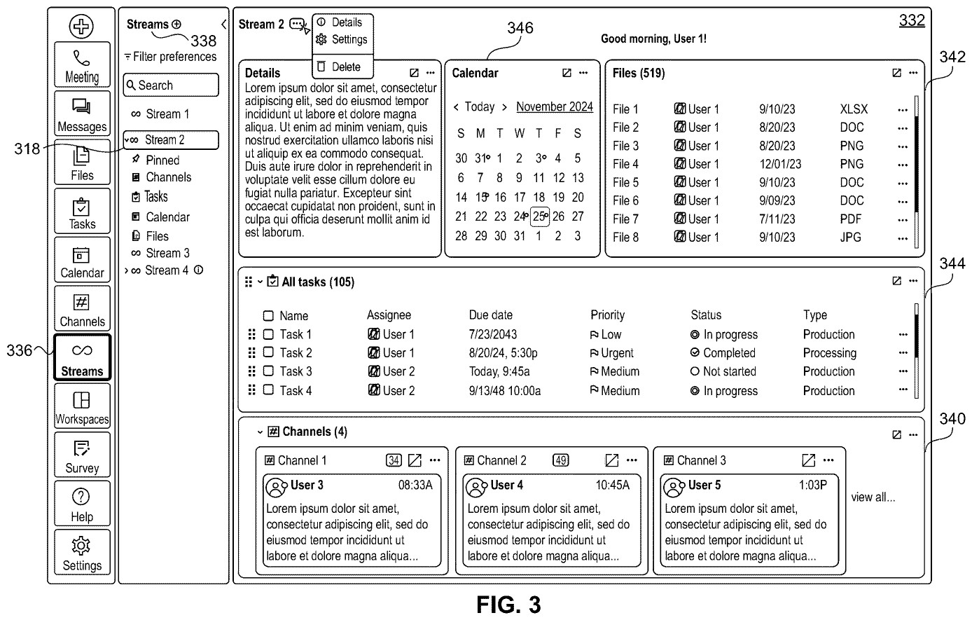

FIGS. 3-7 are diagrams of graphical user interfaces allowing users to interact with tasks within managed streams. The graphical user interfaces provide a visual representation of the associated functional aspects of certain task management processes. The graphical user interface facilitates receiving inputs from a user. In an embodiment, the graphical user interface is a web-based graphical user interface, and can be accessed via any of the common web browsers, such as Internet Explorer, Firefox, Safari, Chrome, etc. In an embodiment, the graphical user interface is an application that runs on a device such as a laptop, computer, a smart phone, or a tablet.

FIG. 3 is a diagram that illustrates a graphical user interface of a streams dashboard 336 displaying a workspace 332, according to some embodiments. Streams dashboard 336 is an example interface enabling a manager or a user to view all information related to a certain project or matter in a centralized interface. Streams dashboard 336 may be generated by messaging system 202 and/or displayed on a client device having permissions 234 to view the content of the streams. The device may receive GUI data from messaging system 202 to construct and/or display streams dashboard 336. Streams dashboard 336 may include a streams index 338 listing streams 318, a workspace 332, at least one chat panel 340, at least one file panel 342, at least one task panel 344, and at least one calendar panel 346.

Streams index 338 may be a list of streams 318 saved or preserved by a user. Streams index 338 may associate links and/or commands with each listed stream 318 such that users may select between the streams 318. In an embodiment, a client device displaying streams dashboard 336 may transmit a user selection to messaging system 202 instantiating the at least one chat panel 340, at least one file panel 342, at least one task panel 344, and at least one calendar panel 346 of workspace 332. The messaging system may then return metadata regarding the newly selected stream 332 so that the client device may update streams dashboard 336 to display the at least one chat panel 340, at least one file panel 342, at least one task panel 344, and at least one calendar panel 346 associated with the newly selected stream 318 and the corresponding workspace 332. Similarly, the messaging system may return GUI layout information so that the previously saved arrangement of the at least one chat panel 340, at least one file panel 342, at least one task panel 344, and at least one calendar panel 346 may be recreated. In an embodiment, a client device may locally store stream and workspace information so that the client device updates streams dashboard 336 based on a stream selection. In an embodiment, the messaging system 202 and/or the client device may update streams index 338 with the title of a newly created stream 318.

Workspace 332 may be a GUI display generated by a client device having permissions 234 to access a stream 318. Messaging server 110 may retrieve workspace GUI metadata from database 116 and/or provide this workspace GUI metadata to the client device. The client device may then use this metadata to generate workspace 332 on streams dashboard 336. In an embodiment, workspace 332 may include at least one chat panel 340, at least one file panel 342, at least one task panel 344, and at least one calendar panel 346 (collectively referred to as “panels”).

Chat panel 340 may represent a graphical user interface for messaging between users 222 related to the corresponding stream 318. Chat panel 340 may include one or more chat channels 224 including one or more division, team, and/or private message chat channels. A user 222 may be able to preserve a layout of chat channels 224 on chat panel 340. Users 222 may view and utilize one or more chat channels 224 to send and receive messages. In an embodiment, a user 222 may view messages from multiple chat channels 224 in the single graphical user interface of chat panel 340. Users who subscribe to multiple chat channels 224 will be able to quickly and efficiently send and receive messages from other chat panel subscribers and will also be able to see a continuous, archived display of messages. This medium of communication will allow users 222 to quickly send and receive messages to and from other users while also creating an organized medium for retrieving past messages. Users 222 will be able to easily access a chat channel 224 and obtain relevant messages from other users 222 subscribed to that chat channel. In an embodiment, the graphical user interface of chat channels 224 within chat panel 340 may resemble an Internet chat room.

File panel 342 may represent a graphical user interface for managing files 226 related to the corresponding stream 318. A user 222 may access file panel 342 to view and/or edit files 226 managed by messaging system 202. For example, messaging system 202 may cause the client device to display a list of available files 226 related to the corresponding stream 318. The user may upload new files 226 to messaging system 202 and/or export files 226 stored by messaging system 202 to a local computing device. A user 222 may also utilize file panel 342 to send file links to other users 222 so that the other users 222 can access the files 226 stored by the messaging system 202. In an embodiment, a user 222 may utilize chat panel 340 in conjunction with file panel 342 to deliver files. For example, a user 222 may use a drag and drop interaction from file panel 342 to chat panel 340 to deliver a file link or the file itself to another user 222 of a chat channel 224. In an embodiment, the messaging system 202 may allow and/or restrict access to stored files 226 based on whether a client is accessing the file 226 via the messaging system 202 or via a generated link. File panel 342 may allow a user 222 to quickly locate a file 226 and share access to the file 226 to users 222 of messaging system 202 as well as users external to the messaging system 202. This integration allows users 222 to quickly deliver files 226 without needing to access separate programs for file delivery.

Task panel 344 may represent a graphical user interface for managing tasks 228 related to the corresponding stream 318. A user 222 may access task panel 344 to view and/or edit tasks 228 managed by messaging system 202. For example, messaging system 202 may cause the client device to display a list of available tasks 228 related to the corresponding stream 318. The user 222 may add tasks 228 to task panel 344 as new objectives arise for the stream 318. The user 222 may remove tasks from task panel 344 as the user 222 completes objectives for the stream 318. Tasks 228 for a user 222 may be assigned by an administrator 220. Each one of tasks 228 displayed on task panel 344 may include a name, a type, a tag, a status, a tracked time, a priority level, a deadline, a description, and/or one or more assigned users. For example, a priority level may be a low level, a medium level, and an urgent level. In another example, a status may be “not started,” “in progress,” or “completed.” Tasks 228 may be tracked by messaging system 202 to generate data reports. For example, messaging system 202 may track an amount of time that a user 222 spends on a particular task 228 for the purpose of calculating billable hours. The use of a matter-based dashboard such as, for example, streams dashboard 336, centralizes information about tasks 228 to assist users 222 with meeting deadlines, preventing oversights, and avoiding unnecessary delays in projects.

Calendar panel 346 may represent a graphical user interface for managing calendars 230 related to the corresponding stream 318. Calendar panel 346 may display meetings, appointments, or reminders for a user 222 based on a calendar 230. The calendar 230 may be tracked by messaging system 202 to generate data reports. For example, messaging system 202 may track an amount of time that a user 222 spends in a particular meeting or appointment for the purpose of calculating billable hours.

In an embodiment, a user 222 may view workspace 332 and/or manipulate workspace 332 to access the at least one chat panel 340, the at least one file panel 342, the at least one task panel 344, and the at least one calendar panel 346. By utilizing a workspace 332, users 222 may select between chat panel 340, file panel 342, task panel 344, and calendar panel 346 for viewing. Users 222 may arrange chat panel 340, file panel 342, task panel 344, and calendar panel 346 in a particular layout, and/or preserve the layout for later viewing. In this manner, users 222 may arrange or organize chat panel 340, file panel 342, task panel 344, and calendar panel 346 into user-specified workspaces 332 so that users 222 can access one or more of the panels simultaneously. Similarly, users 222 may preserve a specific configuration of chat panel 340, file panel 342, task panel 344, and calendar panel 346 for later use so that a user 222 need not create a new arrangement or workspace 332 each time the user 222 accesses the messaging system 202. For example, the user 222 may utilize a drag and drop interaction to move the panels. The messaging system 202 may preserve the configuration based on metadata exchanged between a client device displaying workspace 332 and a messaging server. When a user 222 accesses workspace 332, the messaging system 202 may transmit metadata to the client device, thereby commanding the client device to display workspace 332 and the preserved workspace arrangement of panels. The client device may display workspace 332 via an application installed on the client device and/or an Internet browser accessing a website instance of workspace 332.

In an embodiment, when creating a workspace 332 and/or saving a workspace 332, a user 222 may specify a workspace identifier associated with the created workspace 332. The workspace identifier may be a title, symbol, and/or other user-selected identifier. In an embodiment, the messaging system 202 may provide a workspace identifier when a user 222 initiates the workspace creation process. For example, the messaging system may provide a default workspace identifier, such as, “Workspace A.” The messaging system may continue providing identifiers alphabetically or numerically as new workspaces are created.

In an embodiment, the messaging system 202 may pre-populate a created workspace 332. For example, the messaging system 202 may utilize usage statistics and arrange a workspace 332 with the most frequently used of chat panel 340, file panel 342, task panel 344, and calendar panel 346. After pre-populating a workspace 332, a user 222 may edit the pre-populated panels to add and/or remove other panels. In an embodiment, a user 222 may indicate whether the user wishes for the messaging system 202 to pre-populate a workspace 332 or if the user wishes for the messaging system 202 to provide a blank workspace 332 without any types of panels. The messaging system 202 may generate a workspace 332 according to user preference data maintained in a database.

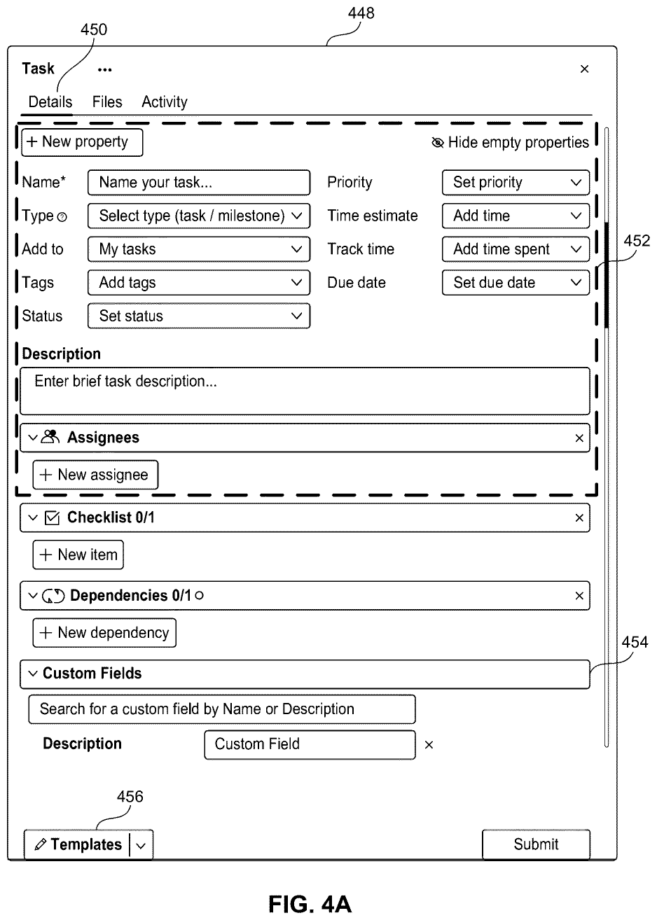

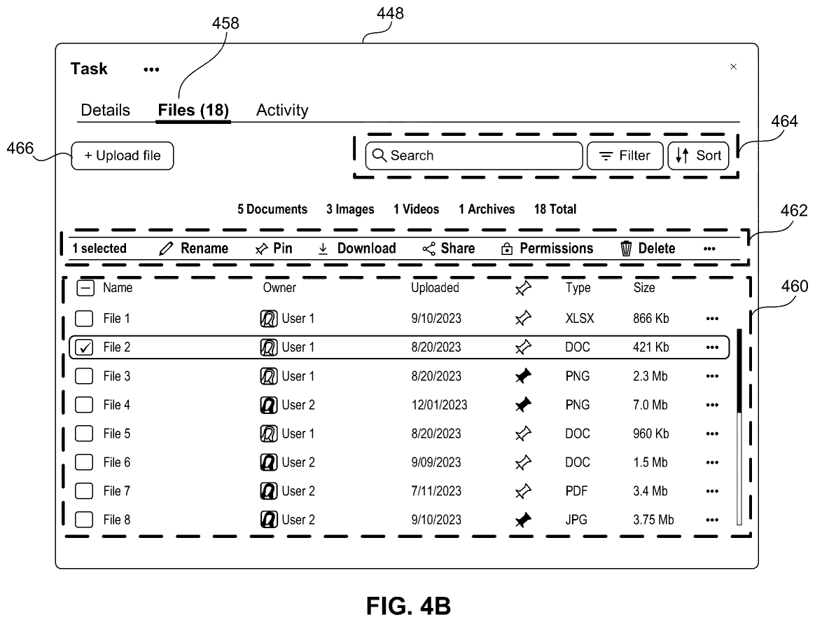

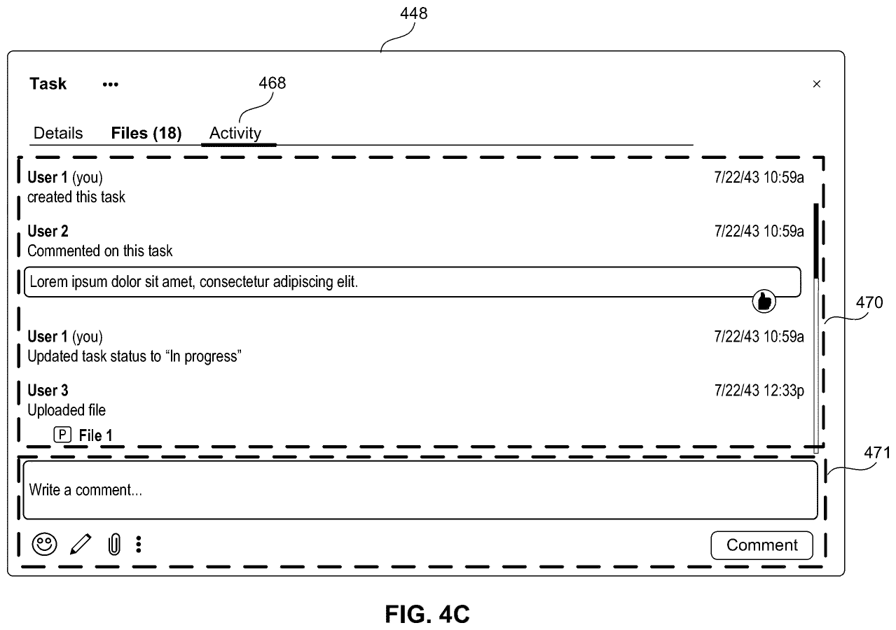

FIGS. 4A-4C are diagrams that illustrate a graphical user interface displaying a task settings panel 448, according to some embodiments. Messaging server 110 may generate a task GUI such as, for example, task setting panel 448, when a user 222 enters a command to create or edit a task 228. Messaging server 110 may receive the command at workspace 332 when user 222 selects a button on workspace 332 to generate the task GUI such as, for example, task setting panel 448. A client device may receive GUI data from messaging system 202 to construct and/or display task settings panel 448. Task settings panel 448 may include a details tab 450, a files tab 458, and an activity tab 468. A user 222 may select between details tab 450, a files tab 458, and an activity tab 468 to view one or more parameters, files, or activity information, respectively.

FIG. 4A is a diagram that illustrates a graphical user interface displaying a details tab 450 of task settings panel 448, according to some embodiments. Details tab 450 is an example interface enabling a user 222 or administrator 220 to set or modify notable information about a corresponding task 228 being created or edited, respectively, with task setting panel 448. Details tab 450 may include one or more parameters 452, one or more custom fields 454, and a template button 456.

Messaging server 110 may receive, via task settings panel 448, a command from a user 222 specifying one or more parameters 452 at corresponding entry fields on details tab 450. The one or more parameters 452 may include at least one of a name, a type, a tag, a status, a tracked time, a priority level, a deadline, a description, or one or more assigned users. Assigned users may be added by entering names or email addresses corresponding to users 222 to add to the task 228 and its corresponding stream 218. The one or more parameters 452 may include custom fields 454 that enable a user 222 to create a customized parameter for the corresponding task 228. A GMA or manager may establish whether certain parameters 452 are required to be provided by a user 222 and whether certain parameters 452 are optional.

In response to receiving the command specifying the one or more parameters 452, messaging server 110 may generate metadata reflecting the one or more parameters 452 as specified by the command. The metadata may then be stored in database 116 for later recall when displaying information about the corresponding task 228 to the user 222. Messaging server 110 may displaying, at a client device, the task 228 according to the metadata on a task panel 344 on a workspace 332 GUI. The task 228 may be displayed as specified in the permissions 234 such that the user 222 is able to view or modify contents of the stream 318 only if the user 222 has a role allowed within the permissions 234.

An administrator 220 or a user 222 may select template button 456 to save a task 228 as a task template, or create a new task 228 from an existing task template, that includes the one or more parameters 452 defined for a particular type of project or matter. The metadata reflecting the one or more parameters 452 as specified by the command may be stored in database 116 as a task template reflecting the specified one or more parameters 452. Administrator 220 may use a task template for a team of users 222 that works together on multiple projects and uses consistent naming conventions and workflows across the matters. For example, administrator 220 may use a task template for a litigation team of users 222 that works together on a variety of projects that each represent a stage of the same litigation case. User 222 may use a task template for a series of recurring types of tasks 228 related to a project or matter. Accordingly, a task template can assist users in repeatedly generating tasks 228 without wasting time configuring the settings of routine tasks.

FIG. 4B is a diagram that illustrates a graphical user interface displaying a files tab 458 of task settings panel 448, according to some embodiments. Files tab 458 is an example interface enabling a user 222 or administrator 220 to view and upload files 226 related to a corresponding task 228 being created or edited, respectively, with task setting panel 448. Files tab 458 may include a file index 460, file commands 462, a file search 464, and a file upload button 466.

File index 460 may be a list of files 226 saved by a user 222 or administrator 220 for a certain task 228. File index 460 may associate links and/or commands with each listed file 226 such that users may select between the files 228. In an embodiment, the messaging system 202 and/or the client device may update file index 460 with a newly added file 226 for the corresponding task 228. In an embodiment, the messaging system 202 and/or the client device may update file index 460 when a file 226 is removed from the corresponding task 228.

File commands 462 may be a list of performable commands for a certain file 226 within the corresponding task 228. File commands 462 may include at least one of rename, pin, download, share, permissions, or delete commands. A rename command may permit an administrator 220 or user 222 to modify the name of a file 226 displayed on file index 460. A pin command may permit an administrator 220 or user 222 to pin a file 226 in a fixed position on file index 460. A download command may permit an administrator 220 or user 222 to download a local version of a file 226 onto the client device. A share command may permit an administrator 220 or user 222 to send to deliver a file link or the file itself to another user within messaging system 202 or a recipient outside of messaging system 202. A permissions command may permit an administrator 220 to modify the permissions to access files 226 on file index 460. A delete command may permit an administrator 220 or user 222 to remove a file 226 from file index 460 and the corresponding task 228.

File search 464 may allow a user to search for a specific file 226 related to the corresponding task 228. In an embodiment, the user may input the name of the file, a description of the file, the file type, an author, editor, or uploader of the file, and/or the name of the user that provided the file to the user. File search 464 may enable a user to filter and/or sort the search results. For example, a user may be able to filter and/or the results by date, chat channels, file folders, contacts, or file type.

File upload 466 may allow a user to add a file 226 to a task 228. In response to receiving a command to upload a file 226, file index 460 may be updated to display the newly added file 226.

FIG. 4C is a diagram that illustrates a graphical user interface displaying an activity tab 468 of task settings panel 448, according to some embodiments. Activity tab 468 is an example interface enabling a user 222 or administrator 220 to view activity history of a corresponding task 228 being created or edited, respectively, with task setting panel 448. Activity tab 468 may include an activity log 470 and a comment field 471.

Activity log 468 may display a chronological list of actions taken by users 222 or administrators 220 in relation to a certain task 228. Messaging system 202 may automatically track each time a user 222 or administrator 220 takes an action related to the task 228 and may update activity log 468 to display the new action. Actions listed on activity log may include a time and date that the action was taken for the task 228. Actions that are displayed on activity log 468 may include creation of a task 228, commenting on a task 228, updating a setting of a task (e.g., one or more parameters 452 such as, for example, a priority level or a status), or uploading a file 226 to the task 228.

Comment field 471 may allow a user 222 or administrator 220 to add comments or notes related to the progress of the corresponding task 228. For example, an administrator 220 may provide directions to the users 222 assigned to the task 228. Any comments entered at comment field 471 may be displayed on activity log 468 as a new action with a time and date.

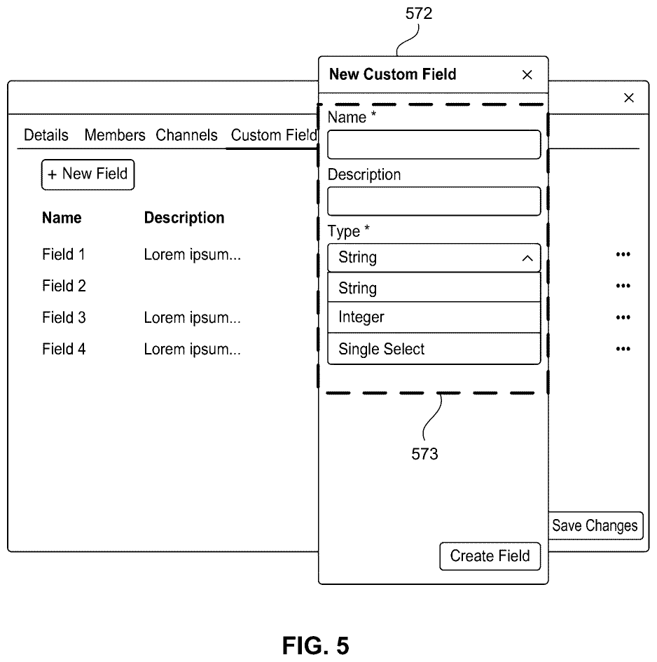

FIG. 5 is a diagram that illustrates a graphical user interface displaying a custom field creation panel 572, according to some embodiments. Messaging server 110 may generate custom field creation panel 572 when a user 222 enters a command to create a customized parameter 452 for display on task settings panel 448 related to a certain task 228. A client device may receive GUI data from messaging system 202 to construct and/or display custom field creation panel 572. Custom field creation panel 572 may include a plurality of entry fields for custom field parameters 573.

Custom field parameters 573 may include a name, a description, or a type parameter. The name parameter of custom field parameters 573 may be a word or phrase that labels the custom field as a parameter 452 for the corresponding task 228. The description parameter of custom field parameters 573 may be one or more phrases or sentences that provide context for the custom field as a parameter 452 for the corresponding task 228. The type parameter of custom field parameters 573 can set the custom field as a string type, an integer type, or a selection button type of parameter 452 for the corresponding task 228. In this configuration, an administrator 220 or user 222 can create custom fields as one or more parameters 452 unique to a certain project or matter by using custom field creation panel 572.

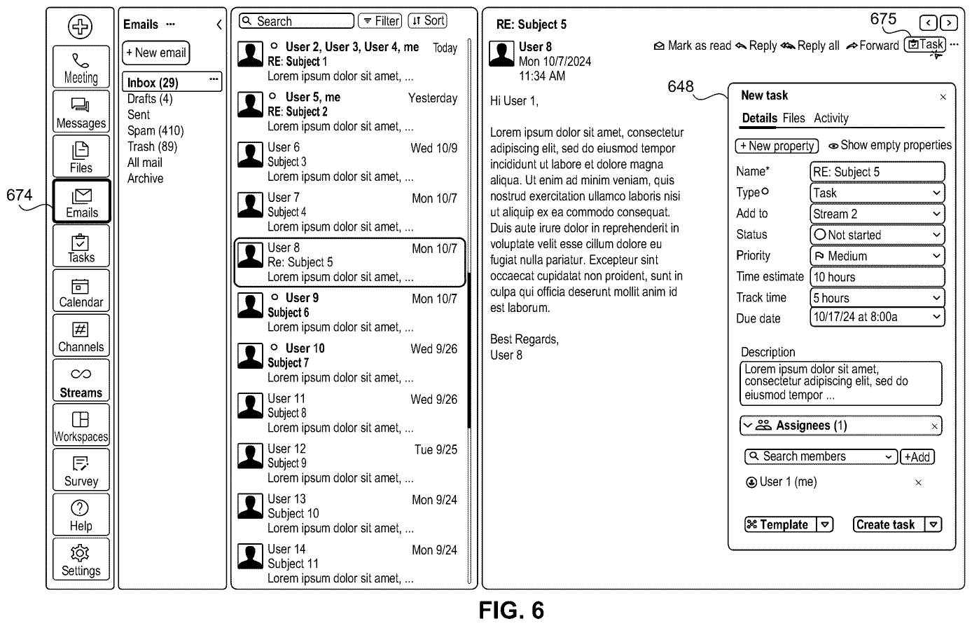

FIG. 6 is a diagram that illustrates a graphical user interface displaying a task settings panel 648 activated on an email interface 674, according to some embodiments. Email interface 674 displays a view that may be displayed on a client device. Email interface 674 may provide a list of emails and/or groups of emails on a subject directed to a user and may display a preview of the email. Email interface 674 may also display information related to the sender of the email. For example, email interface 674 may display the sender of the email, the time the email was sent, and/or the time the email was received. Using email interface 674, the user may select between different emails. In an embodiment, users may also interact with email interface 674 to delete, hide, and/or edit email messages. In an embodiment, email interface 674 may include a search feature, allowing a user to search through previous email responses. Messaging system 202 may filter search results to display emails that include a desired search term or similar terms.

Email interface 674 may provide a user with text formatting tools as well non-text features, such as, for example, images, videos, audio, and tables to include in a response. Email interface 674 may also include an upload feature for uploading files to a response. Users may selectively choose whether to send uploaded files to only users of messaging system 202 or to both users and external individuals.

In an embodiment, the users 222 may wish to communicate with external individuals that do not have access to messaging system 202. While not being able to utilize messaging system 202, external individuals may have email access and/or a corresponding email address. Messaging system 202 may accept and/or generate emails to communicate with these external individuals. When receiving external emails, messaging system 202 parses the emails, identifying external individuals as well as users 222 of messaging system 202. Messaging system 202 may also hide certain repetitious portions of email threads based on the parsing. In an embodiment, messaging system 202 displays the email and/or email thread using a chat panel. This chat panel may allow recipients to communicate via email while displaying the email as a chat interface. In an embodiment, external individuals may receive response emails from users 222 while users 222 of messaging system 202 may receive responses in the form of chat messages.

If a response is intended for a user of messaging system 202 as well as an external individual, messaging system 202 may identify the permissions associated with each recipient, preserving chat features for users of messaging system 202 and possibly restricting portions of the message to external individuals. For example, messaging system 202 may deliver a link to an internally stored image or document to a user when the image or document is referenced in the response but may deliver the image or document file to an external individual. This integration allows for quick communication and delivery of responses to both users of messaging system 202 as well as external individuals.

Email interface 674 may include a task button 675. Messaging server 110 may receive a command at the email interface 674 to generate a task settings panel 648 GUI. Task settings panel 648 may operate as task settings panel 448 described above with regard to FIGS. 4A-4C. Messaging system 202 may detect information from an email and auto-populate entry fields on task settings panel 648 for one or more parameters 452 for a task 228. For example, an email subject, an email description, and email recipients may be designated as a name, a description, and assigned users, respectively, for the parameters 452 of the task 228. Accordingly, messaging system 202 may use email integration to seamlessly convert emails to tasks 228 so that users may work from a centralized dashboard for all matter-related items.

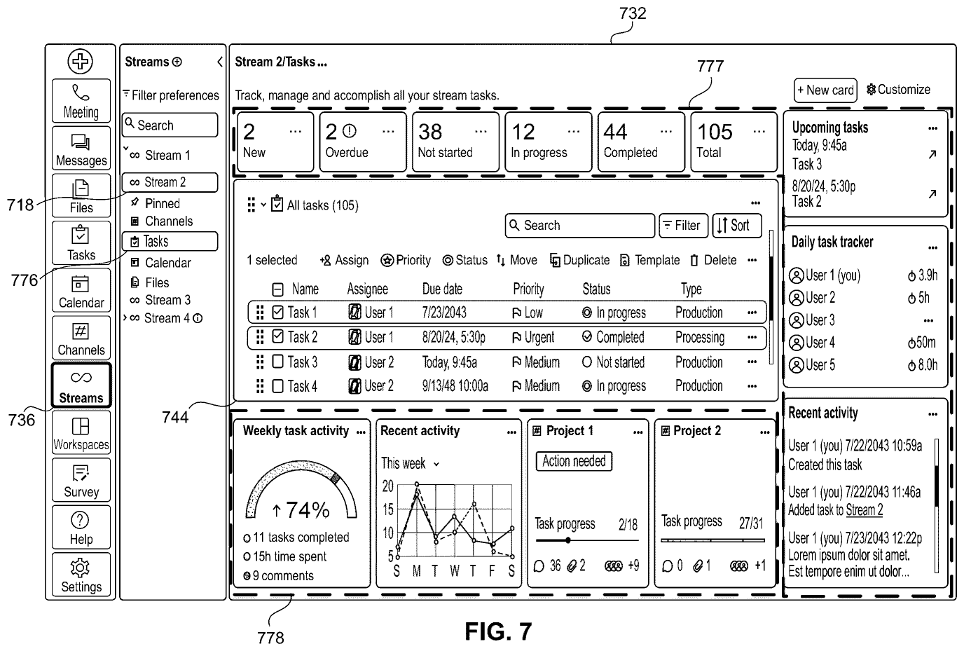

FIG. 7 is a diagram that illustrates a graphical user interface displaying a tasks dashboard 776 on a streams dashboard 736, according to some embodiments. Streams dashboard 736 may operate similarly to streams dashboard 336 as described with regard to FIG. 3. Tasks dashboard 776 is an example graphical user interface enabling a manager or a user to view all task-related information corresponding to a certain project or matter in a centralized interface. For example, an administrator 220 may use tasks dashboard 776 to view all tasks 228 managed by the administrator 220 across multiple streams 718. Tasks dashboard 776 may be generated by messaging system 202 and/or displayed on a client device having permissions 234 to view the content of the streams. The device may receive GUI data from messaging system 202 to construct and/or display tasks dashboard 776. Tasks dashboard 776 may include at least one task panel 744, at least one status panel 777, and at least one data reporting panel 778 (collectively referred to as “panels”). The at least one task panel 744, at least one status panel 777, and at least one data reporting panel 778 may be arranged on tasks dashboard 776 as a workspace 732.

Task panel 744 may operate similarly to task panel 344 as described with regard to FIG. 3. Task panel 744 may represent a graphical user interface for managing tasks 228 in one or more streams 718. A user may access task panel 744 to view and/or edit tasks 228 managed by messaging system 202. For example, messaging system 202 may cause the client device to display a list of available tasks 228 related to the corresponding stream 718. The user may add tasks 228 to task panel 744 as new objectives arise for the stream 718. The user may remove tasks from task panel 744 as the user completes objectives for the stream 718. Tasks 228 for a user may be assigned by an administrator 220. Each one of tasks 228 displayed on task panel 744 may include a name, a type, a tag, a status, a tracked time, a priority level, a deadline, a description, and/or one or more assigned users. For example, a priority level may be a low level, a medium level, and an urgent level. In another example, a status may be “not started,” “in progress,” or “completed.”

A user may select performable commands for tasks 228 displayed in task panel 744. The performable commands may include at least one of assign, priority, status, move, duplicate, template, or delete commands. An assign command may permit a user to assign other users to a certain task 228 on task panel 744. A priority command may permit a user to set a priority level for a certain task 228 on task panel 744. A status command may permit a user to set a status for a certain task 228 on task panel 744. A move command may permit a user to change a location of a certain task 228 on task panel 744. A duplicate command may permit a user to create a copy of a certain task 228 on task panel 744. A template command may permit a user to select a certain task 228 and the corresponding parameters 452 for use as a task template. A delete command may permit a user to remove a certain task 228 from task panel 744.

Status panel 777 may represent a graphical user interface for viewing statuses and progress of tasks 228 in one or more streams 718. Status panel 777 may sort tasks 228 according to status and/or priority level. For example, tasks 228 may be grouped into status and/or priority levels that include “new,” “overdue,” “not started,” “in progress,” “completed,” or “total.” Status panel 777 may display a number of tasks 228 that correspond to each status or priority level. Status panel 777 may sort tasks 228 according to deadline. For example, status panel 777 may display a chronological list of deadlines for each task 228 by a time and date. Status panel 777 may provide a time tracker that tracks how long a particular user has spent on a certain task 228. Status panel 777 may provide an activity log, similar to activity log 468, that displays a chronological list of actions taken by users or administrators in relation to a certain task 228. Messaging system 202 may automatically track each time a user or administrator takes an action related to the task 228 and may update activity log 468 to display the new action. Actions listed on activity log may include a time and date that the action was taken for the task 228.

Data reporting panel 778 may represent a graphical user interface for viewing data analytics of tasks 228 in one or more streams 718. Tasks 228 may be tracked by messaging system 202 to generate data reports to provide managers with concise information summaries. For example, messaging system 202 may track an amount of time that a user spends on a particular task 228 to produce a productivity report that can be used for calculating billable hours. Data reporting panel 778 may display statistics regarding a completion percentage of tasks 228 and/or a completed amount of tasks 228 within a certain timeframe. Data reporting panel 778 may display statistics on progress regarding how many tasks 228 remain to complete a project or matter. The use of a centralized interface such as, for example, tasks dashboard 776, for data collection regarding tasks 228 can help with decision-making for resource allocation, team efficiency, outsourcing work, risk management, and compliance.

### Example Method

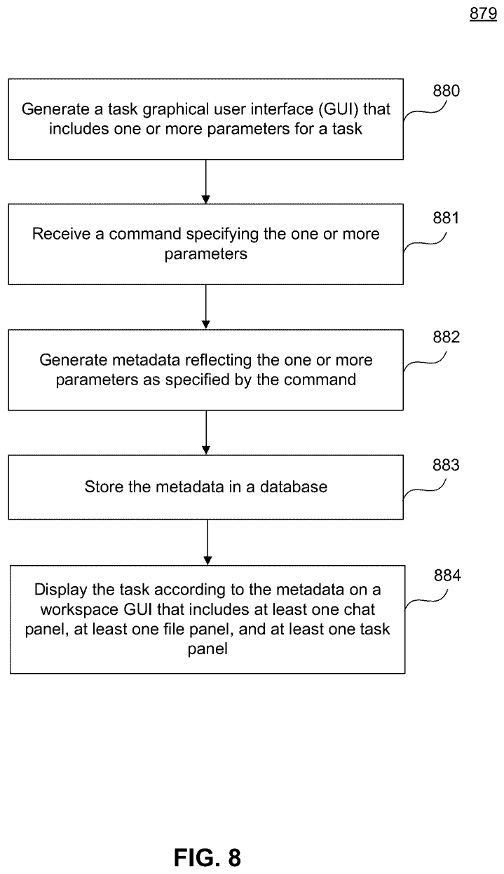

FIG. 8 is a flowchart that illustrates a method 879 for creating a task, according to some embodiments. The foregoing description will describe an embodiment of the execution of method 879 with respect to the components of FIGS. 1-7. While method 879 is described with reference to messaging system 102, method 879 may be executed on any computing device, such as, for example, the computer system described with reference to FIG. 9 and/or processing logic that may comprise hardware (e.g., circuitry, dedicated logic, programmable logic, microcode, etc.), software (e.g., instructions executing on a processing device), or a combination thereof.

It is to be appreciated that not all steps may be needed to perform the disclosure provided herein. Further, some of the steps may be performed simultaneously, or in a different order than shown in FIG. 8, as will be understood by a person of ordinary skill in the art.

At step 880, a messaging server (e.g., messaging server 110 as shown in and described with reference to FIG. 1) may generate a task graphical user interface (GUI) (e.g., task settings panel 448 as shown in and described with reference to FIGS. 4A-4C) that includes one or more parameters (e.g., parameters 452 as shown in and described with reference to FIG. 4A) for a task (e.g., task 228 as shown in and described with reference to FIG. 2) in a stream (e.g., stream 218 as shown in and described with reference to FIG. 2), the stream having permissions (e.g., permissions 234 as shown in and described with reference to FIG. 2) specifying which role a user must have to access the stream. Access to the stream includes at least one of read-only permissions of the contents of the stream, permissions to edit contents of the stream, or administrative permissions to edit permissions for other users in the stream.

At step 881, the messaging server may receive, via the task GUI, a command specifying the one or more parameters. For the one or more parameters, the command may specify at least one of a name, a type, a tag, a status, a tracked time, a priority level, a deadline, a description, or one or more assigned users.

At step 882, in response to the command, the messaging server may generate metadata reflecting the one or more parameters as specified by the command.

At step 883, the messaging server may store the metadata in a database (e.g., database 116 as shown in and described with reference to FIG. 1). The metadata may be stored as a task template reflecting the one or more parameters as specified by the command.

At step 884, the messaging server may display, at a client device (e.g., user device 106 or administrator device 108 as shown in and described with reference to FIG. 1), the task according to the metadata on a workspace GUI (e.g., workspace 332 as shown in and described with reference to FIG. 3) that includes at least one chat panel (e.g., chat panel 340 as shown in and described with reference to FIG. 3), at least one file panel (e.g., file panel 342 as shown in and described with reference to FIG. 3), and at least one task panel (e.g., task panel 344 as shown in and described with reference to FIG. 3). The workspace GUI may further include at least one calendar panel (e.g., calendar panel 346 as shown in and described with reference to FIG. 3). The task may be displayed on the workspace GUI as specified in the permissions such that the user is able to view or modify contents of the stream only if the user has a role allowed within the permissions.

In an embodiment, method 879 may further include receiving a command at the workspace GUI or at an email GUI to generate the task GUI. The command to generate the task GUI may be received before step 880.

In an embodiment, method 879 may further include displaying the task according to the metadata on a tasks dashboard GUI (e.g., tasks dashboard 776 as shown in and described with reference to FIG. 7) that includes at least one task panel (e.g., task panel 744 as shown in and described with reference to FIG. 7), at least one status panel (e.g., status panel 777 as shown in and described with reference to FIG. 7), and at least one data reporting panel (e.g., data reporting panel 778 as shown in and described with reference to FIG. 7).

### Example Computer System

Various embodiments may be implemented, for example, using one or more well-known computer systems, such as computer system 985 shown in FIG. 9. One or more computer systems 985 may be used, for example, to implement any of the embodiments discussed herein, as well as combinations and sub-combinations thereof.

Computer system 985 may include one or more processors (also called central processing units, or CPUs), such as a processor 988. Processor 988 may be connected to a communication infrastructure or bus 989.

Computer system 985 may also include user input/output device(s) 987, such as monitors, keyboards, pointing devices, etc., which may communicate with communication infrastructure 989 through user input/output interface(s) 986.

One or more of processors 988 may be a graphics processing unit (GPU). In an embodiment, a GPU may be a processor that is a specialized electronic circuit designed to process mathematically intensive applications. The GPU may have a parallel structure that is efficient for parallel processing of large blocks of data, such as mathematically intensive data common to computer graphics applications, images, videos, etc.

Computer system 985 may also include a main or primary memory 990, such as random access memory (RAM). Main memory 990 may include one or more levels of cache. Main memory 990 may have stored therein control logic (i.e., computer software) and/or data.

Computer system 985 may also include one or more secondary storage devices or memory 991. Secondary memory 991 may include, for example, a hard disk drive 992 and/or a removable storage device or drive 993. Removable storage drive 993 may be a floppy disk drive, a magnetic tape drive, a compact disk drive, an optical storage device, tape backup device, and/or any other storage device/drive.

Removable storage drive 993 may interact with a removable storage unit 994. Removable storage unit 994 may include a computer usable or readable storage device having stored thereon computer software (control logic) and/or data. Removable storage unit 994 may be a floppy disk, magnetic tape, compact disk, DVD, optical storage disk, and/any other computer data storage device. Removable storage drive 993 may read from and/or write to removable storage unit 994.

Secondary memory 991 may include other means, devices, components, instrumentalities or other approaches for allowing computer programs and/or other instructions and/or data to be accessed by computer system 985. Such means, devices, components, instrumentalities or other approaches may include, for example, a removable storage unit 996 and an interface 995. Examples of the removable storage unit 996 and the interface 995 may include a program cartridge and cartridge interface (such as that found in video game devices), a removable memory chip (such as an EPROM or PROM) and associated socket, a memory stick and USB port, a memory card and associated memory card slot, and/or any other removable storage unit and associated interface.

Computer system 985 may further include a communication or network interface 997. Communication interface 997 may enable computer system 985 to communicate and interact with any combination of external devices, external networks, external entities, etc. (individually and collectively referenced by reference number 999). For example, communication interface 997 may allow computer system 985 to communicate with external or remote devices 999 over communications path 998, which may be wired and/or wireless (or a combination thereof), and which may include any combination of LANs, WANs, the Internet, etc. Control logic and/or data may be transmitted to and from computer system 985 via communication path 998.

Computer system 985 may also be any of a personal digital assistant (PDA), desktop workstation, laptop or notebook computer, netbook, tablet, smart phone, smart watch or other wearable, appliance, part of the Internet-of-Things, and/or embedded system, to name a few non-limiting examples, or any combination thereof.

Computer system 985 may be a client or server, accessing or hosting any applications and/or data through any delivery paradigm, including but not limited to remote or distributed cloud computing solutions; local or on-premises software (“on-premise” cloud-based solutions); “as a service” models (e.g., content as a service (CaaS), digital content as a service (DCaaS), software as a service (SaaS), managed software as a service (MSaaS), platform as a service (PaaS), desktop as a service (DaaS), framework as a service (FaaS), backend as a service (BaaS), mobile backend as a service (MBaaS), infrastructure as a service (IaaS), etc.); and/or a hybrid model including any combination of the foregoing examples or other services or delivery paradigms.

Any applicable data structures, file formats, and schemas in computer system 985 may be derived from standards including but not limited to JavaScript Object Notation (JSON), Extensible Markup Language (XML), Yet Another Markup Language (YAML), Extensible Hypertext Markup Language (XHTML), Wireless Markup Language (WML), MessagePack, XML User Interface Language (XUL), or any other functionally similar representations alone or in combination. Alternatively, proprietary data structures, formats or schemas may be used, either exclusively or in combination with known or open standards.

In some embodiments, a tangible, non-transitory apparatus or article of manufacture comprising a tangible, non-transitory computer useable or readable medium having control logic (software) stored thereon may also be referred to herein as a computer program product or program storage device. This includes, but is not limited to, computer system 985, main memory 990, secondary memory 991, and removable storage units 994 and 996, as well as tangible articles of manufacture embodying any combination of the foregoing. Such control logic, when executed by one or more data processing devices (such as computer system 985), may cause such data processing devices to operate as described herein.

Based on the teachings contained in this disclosure, it will be apparent to persons skilled in the relevant art(s) how to make and use embodiments of this disclosure using data processing devices, computer systems and/or computer architectures other than that shown in FIG. 9. In particular, embodiments can operate with software, hardware, and/or operating system implementations other than those described herein.

It is to be appreciated that the Detailed Description section, and not any other section, is intended to be used to interpret the claims. Other sections can set forth one or more but not all exemplary embodiments as contemplated by the inventor(s), and thus, are not intended to limit this disclosure or the appended claims in any way.

While this disclosure describes exemplary embodiments for exemplary fields and applications, it should be understood that the disclosure is not limited thereto. Other embodiments and modifications thereto are possible, and are within the scope and spirit of this disclosure. For example, and without limiting the generality of this paragraph, embodiments are not limited to the software, hardware, firmware, and/or entities illustrated in the figures and/or described herein. Further, embodiments (whether or not explicitly described herein) have significant utility to fields and applications beyond the examples described herein.

Embodiments have been described herein with the aid of functional building blocks illustrating the implementation of specified functions and relationships thereof. The boundaries of these functional building blocks have been arbitrarily defined herein for the convenience of the description. Alternate boundaries can be defined as long as the specified functions and relationships (or equivalents thereof) are appropriately performed. Also, alternative embodiments can perform functional blocks, steps, operations, methods, etc. using orderings different than those described herein.

References herein to “one embodiment,” “an embodiment,” “an example embodiment,” or similar phrases, indicate that the embodiment described can include a particular feature, structure, or characteristic, but every embodiment can not necessarily include the particular feature, structure, or characteristic. Moreover, such phrases are not necessarily referring to the same embodiment. Further, when a particular feature, structure, or characteristic is described in connection with an embodiment, it would be within the knowledge of persons skilled in the relevant art(s) to incorporate such feature, structure, or characteristic into other embodiments whether or not explicitly mentioned or described herein. Additionally, some embodiments can be described using the expression “coupled” and “connected” along with their derivatives. These terms are not necessarily intended as synonyms for each other. For example, some embodiments can be described using the terms “connected” and/or “coupled” to indicate that two or more elements are in direct physical or electrical contact with each other. The term “coupled,” however, can also mean that two or more elements are not in direct contact with each other, but yet still co-operate or interact with each other.

The breadth and scope of this disclosure should not be limited by any of the above-described exemplary embodiments, but should be defined only in accordance with the following claims and their equivalents.

What is claimed is:

1. A computer-implemented method, comprising:
generating, by a messaging server, a task graphical user interface (GUI) that includes one or more parameters for a task in a stream, the stream having permissions specifying which role a user must have to access the stream;
receiving, by the messaging server and via the task GUI, a command specifying the one or more parameters;
generating, by the messaging server, metadata reflecting the one or more parameters as specified by the command;
storing, by the messaging server, the metadata in a database;
displaying, by the messaging server and at a client device, the task according to the metadata on a workspace GUI that includes at least one chat panel, at least one file panel, and at least one task panel.

2. The computer-implemented method of claim 1, wherein the receiving the command specifying the one or more parameters comprises receiving a command specifying at least one of a name, a type, a tag, a status, a tracked time, a priority level, a deadline, a description, or one or more assigned users.

3. The computer-implemented method of claim 1, wherein the storing the metadata in the database comprises storing the metadata as a task template reflecting the one or more parameters as specified by the command.

4. The computer-implemented method of claim 1, wherein the displaying the task comprises displaying the task on the workspace GUI that further includes at least one calendar panel.

5. The computer-implemented method of claim 1, wherein the displaying the task comprises displaying the task on the workspace GUI as specified in the permissions such that the user is able to view or modify contents of the stream only if the user has a role allowed within the permissions.

6. The computer-implemented method of claim 1, further comprising receiving a command at the workspace GUI or at an email GUI to generate the task GUI.

7. The computer-implemented method of claim 1, further comprising displaying the task according to the metadata on a tasks dashboard GUI that includes at least one task panel, at least one status panel, and at least one data reporting panel.

8. A system, comprising:
a database;
a messaging server configured to:
generate a task graphical user interface (GUI) that includes one or more parameters for a task in a stream, the stream having permissions specifying which role a user must have to access the stream;
receive, via the task GUI, a command specifying the one or more parameters;
generate metadata reflecting the one or more parameters as specified by the command;
store the metadata in a database;
display, at a client device, the task according to the metadata on a workspace GUI that includes at least one chat panel, at least one file panel, and at least one task panel.

9. The system of claim 8, wherein the one or more parameters comprise at least one of a name, a type, a tag, a status, a tracked time, a priority level, a deadline, a description, or one or more assigned users.

10. The system of claim 8, wherein the metadata is configured to be stored as a task template reflecting the one or more parameters as specified by the command.

11. The system of claim 8, wherein the workspace GUI further includes at least one calendar panel.

12. The system of claim 8, wherein the displaying the task comprises displaying the task on the workspace GUI as specified in the permissions such that the user is able to view or modify contents of the stream only if the user has a role allowed within the permissions.

13. The system of claim 8, wherein the messaging server is further configured to receive a command at the workspace GUI or at an email GUI to generate the task GUI.

14. The system of claim 8, wherein the messaging server is further configured to display the task according to the metadata on a tasks dashboard GUI that includes at least one task panel, at least one status panel, and at least one data reporting panel.

15. A non-transitory computer-readable device having instructions stored thereon that, when executed by at least one computing device, causes the at least one computing device to perform operations comprising:
generating, by a messaging server, a task graphical user interface (GUI) that includes one or more parameters for a task in a stream, the stream having permissions specifying which role a user must have to access the stream;
receiving, by the messaging server and via the task GUI, a command specifying the one or more parameters;
generating, by the messaging server, metadata reflecting the one or more parameters as specified by the command;
storing, by the messaging server, the metadata in a database;
displaying, by the messaging server and at a client device, the task according to the metadata on a workspace GUI that includes at least one chat panel, at least one file panel, and at least one task panel.

16. The non-transitory computer-readable device of claim 15, wherein the receiving the command specifying the one or more parameters comprises receiving a command specifying at least one of a name, a type, a tag, a status, a tracked time, a priority level, a deadline, a description, or one or more assigned users.

17. The non-transitory computer-readable device of claim 15, wherein the storing the metadata in the database comprises storing the metadata as a task template reflecting the one or more parameters as specified by the command.

18. The non-transitory computer-readable device of claim 15, wherein the displaying the task comprises displaying the task on the workspace GUI as specified in the permissions such that the user is able to view or modify contents of the stream only if the user has a role allowed within the permissions.

19. The non-transitory computer-readable device of claim 15, the operations further comprising receiving a command at the workspace GUI or at an email GUI to generate the task GUI.

20. The non-transitory computer-readable device of claim 15, the operations further comprising displaying the task according to the metadata on a tasks dashboard GUI that includes at least one task panel, at least one status panel, and at least one data reporting panel.
